(19) United States
(12) Patent Application Publication
(10) Pub. No.: US 2025/0392905 A1
(43) Pub. Date: Dec. 25, 2025

(54) INFORMATION PROCESSING METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Jin Hua WU, Beijing (CN)

(21) Appl. No.: 18/874,015

(22) PCT Filed: Jun. 23, 2022
(86) PCT No.: PCT/CN2022/100932

§ 371 Date: Dec. 11, 2024

(51) Int. Cl. H04W 12/02; H04W 4/029; H04W 8/20

(52) U.S. Cl. CPC H04W 12/02; H04W 4/029; H04W 8/20

(57) ABSTRACT

An information processing method is performed by a user equipment (UE) and includes: transmitting a privacy setting request to an access and mobility management function (AMF), wherein the privacy setting request includes first identifier information of an internet-of-things (IoT) device and privacy indication information, and the privacy indication information is configured to indicate that a location service (LCS) client is allowed to perform at least one of tracking or locating on the IoT device.

### CROSS REFERENCE TO RELATED APPLICATIONS

This application is a US National Phase of International Application No. PCT/CN2022/100932, filed on Jun. 23, 2022, the entire content of which is incorporated herein by reference in its entirety.

### TECHNICAL FIELD

The present disclosure relates to but not limited to the field of wireless communication technologies and in particular to an information processing method and apparatus, a communication device and a storage medium.

### BACKGROUND

In the 3rd generation partnership project (3GPP) standard, location service function should be supported to allow developing new and innovative location-based services. For example, a current location of user equipment (UE) can be identified and reported in a standard format (e.g. geographical coordinate) to allow information of the current location to be used for a user, a mobile equipment (ME), a network operator, a service provider, a value-added service provider and internal operation of a public land mobile network (PLMN). But in the location tracking services, there is no existing tracking solution in the mobile networks to manage who can track an internet-of-things (IoT) device of a UE owner.

### SUMMARY

According to a first aspect of the present disclosure, there is provided an information processing method, performed by a user equipment (UE) and including:
transmitting a privacy setting request to an access and mobility management function (AMF), where the privacy setting request includes first identifier information of an internet-of-things (IoT) device and privacy indication information, and the privacy indication information is configured to indicate that a location service (LCS) client is allowed to track and/or locate the IoT device.

According to a second aspect of the present disclosure, there is provided an information processing method, performed by an access and mobility management function (AMF) and including:
receiving a privacy setting request from a user equipment (UE), where the privacy setting request includes first identifier information of an internet-of-things (IoT) device and privacy indication information, and the privacy indication information is configured to indicate that a location service (LCS) client is allowed to track and/or locate the IoT device.

According to a third aspect of the present disclosure, there is provided an information processing method, performed by a unified data management (UDM) and including:
receiving an update request from an access and mobility management function (AMF), where the update request includes a privacy setting request, the privacy setting request includes first identifier information of an internet-of-things (IoT) device and privacy indication information, the privacy indication information is configured to indicate that a location service (LCS) client is allowed to track and/or locate the IoT device, and the update request is configured to update LCS privacy information of the first identifier information.

According to a fourth aspect of the present disclosure, there is provided an information processing method, performed by a network function (NF) and including:
transmitting an update notification to a unified data management (UDM), where the update notification is configured to subscribe to updated location service (LCS) privacy information; and
receiving an update response from the UDM, where the update response includes at least the updated LCS privacy information of first identifier information, and the first identifier information is identifier information of an internet-of-things (IoT) device.

According to a fifth aspect of the present disclosure, there is provided an information processing method, including:
transmitting, by a network function (NF), an update notification to a unified data management (UDM), where the update notification is configured to subscribe to updated location service (LCS) privacy information;
transmitting, by a user equipment (UE), a privacy setting request to an access and mobility management function (AMF), where the privacy setting request includes first identifier information of an internet-of-things (IoT) device, second identifier information of at least one LCS client, and privacy indication information, and the privacy indication information is configured to indicate that the LCS client is allowed to track and/or locate the IoT device;
after receiving the privacy setting request, transmitting, by the AMF, an update request carrying the privacy setting request to the UDM;
determining, by the UDM based on the update request and subscription information, that the first identifier information is based on third identifier information, and adding the second identifier information to the LCS privacy information of the first identifier information, where the third identifier information is identifier information of the UE; and
transmitting, by the UDM, an update response to the NF, where the update response includes at least the updated LCS privacy information of the first identifier information.

According to a sixth aspect of the present disclosure, there is provided a communication device, including:
a processor; and
a memory storing instructions executable by the processor;
where the processor is configured to perform the information processing method in the first, second, third, or fourth aspect.

According to an seventh aspect of the present disclosure, there is provided a computer storage medium, storing computer-executable programs thereon, where the computer-executable programs, when executed by a processor, cause the processor to perform the information processing method in the first, second, third, or fourth aspect.

It should be understood that the above general descriptions and subsequent detailed descriptions are only illustrative and explanatory rather than limiting of the present disclosure.

### BRIEF DESCRIPTION OF THE DRAWINGS

FIG. 1 is a structural schematic diagram illustrating a wireless communication system according to an embodiment of the present disclosure.

FIG. 2 is a schematic diagram illustrating a 5GS LCS architecture reference model of a non-roaming UE according to an embodiment of the present disclosure.

FIG. 3 is a schematic diagram illustrating a 5GC mobile terminated location request (5GC-MT-LR) process of a commercial location service according to an embodiment of the present disclosure.

FIG. 4 is a schematic diagram illustrating an information processing method according to an embodiment of the present disclosure.

FIG. 5 is a schematic diagram illustrating an information processing method according to an embodiment of the present disclosure.

FIG. 6 is a schematic diagram illustrating an information processing method according to an embodiment of the present disclosure.

FIG. 7 is a schematic diagram illustrating an information processing method according to an embodiment of the present disclosure.

FIG. 8 is a schematic diagram illustrating an information processing method according to an embodiment of the present disclosure.

FIG. 9 is a schematic diagram illustrating an information processing method according to an embodiment of the present disclosure.

FIG. 10 is a schematic diagram illustrating an information processing method according to an embodiment of the present disclosure.

FIG. 11 is a schematic diagram illustrating an information processing method according to an embodiment of the present disclosure.

FIG. 12 is a block diagram illustrating an information processing apparatus according to an embodiment of the present disclosure.

FIG. 13 is a block diagram illustrating an information processing apparatus according to an embodiment of the present disclosure.

FIG. 14 is a block diagram illustrating an information processing apparatus according to an embodiment of the present disclosure.

FIG. 15 is a block diagram illustrating an information processing apparatus according to an embodiment of the present disclosure.

FIG. 16 is a block diagram illustrating a UE according to an embodiment of the present disclosure.

FIG. 17 is a block diagram illustrating a base station according to an embodiment of the present disclosure.

### DETAILED DESCRIPTION OF THE EMBODIMENTS

Examples will be described in detail herein, with the illustrations thereof represented in the drawings. Where the following description relates to the drawings, unless otherwise indicated, the same numerals in different drawings represent the same or similar elements. The embodiments described in the following exemplary embodiments do not represent all embodiments consistent with the present disclosure. Instead, they are merely examples of device and methods consistent with certain aspects of the disclosure, as detailed in the appended claims.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

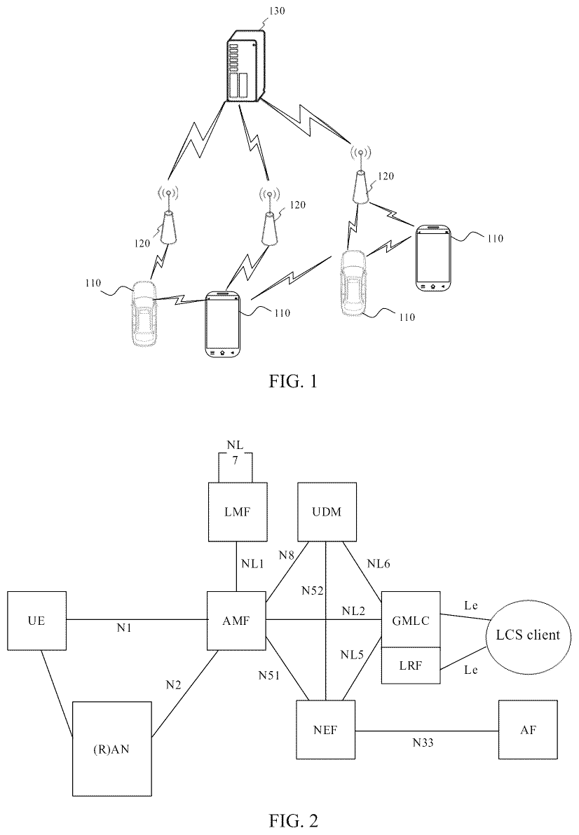

FIG. 1 is a schematic structural diagram illustrating a wireless communication system according to an embodiment of the present disclosure. As shown in FIG. 1, the wireless communication system is a communication system based on the cellular mobile communication technology, which may include a plurality of user equipments (UEs) 110 and a plurality of base stations 120.

The UE 110 may be a device that provides voice and/or data connectivity to users. The UE 110 can communicate with one or more core networks via a radio access network (RAN). The UE 110 can be an IoT UE, such as a sensor device, a mobile phone (or a “cellular” phone) and a computer with an IoT UE. For example, it can be a fixed, portable, pocket-sized, handheld, computer-built or on-board device. For example, a station (STA), a subscriber unit, a subscriber station, a mobile station, a remote station, an access point, a remote terminal, an access terminal, a user terminal, a user agent, a user device or a UE. Alternatively, the UE 110 may be a device of an unmanned aerial vehicle. Alternatively, the UE 110 may also be an on-board device, for example, a driving computer with wireless communication function, or a wireless UE externally connected to the driving computer. Alternatively, the UE 110 may also be a roadside device, such as a street lamp, a signal lamp or other roadside device with wireless communication function.

The base station 120 may be a network device in a wireless communication system. The wireless communication system can be the 4th (4G) generation mobile communication system, also known as long term evolution (LTE) system. Alternatively, the wireless communication system can also be a 5G system, also known as a new radio (NR) system or a 5G NR system. Alternatively, the wireless communication system can also be a next generation system of the 5G system. The access network in the 5G system can be called a new generation-radio access network (NG-RAN).

The base station 120 may be an evolved node B (eNB) adopted in the 4G system.

Alternatively, the base station 120 may also be a g-node-B (gNB) adopting a centralized and distributed architecture in the 5G system. When the base station 120 adopts a centralized and distributed architecture, the base station 12 usually includes a central unit (CU) and at least two distributed units (DUs). The centralized unit is provided with a protocol stack of packet data convergence protocol (PDCP) layer, radio link control (RLC) layer and medium access control (MAC) layer. The distributed unit is provided with a physical (PHY) layer protocol stack. The embodiments of the present disclosure does not limit the specific implementation of the base station 120.

A wireless connection can be established between the base station 120 and the UE 110 through a wireless air interface. In different embodiments, the wireless air interface is based on the fourth generation (4G) mobile communication network technology standard. Alternatively, the wireless air interface is based on the fifth generation (5G) mobile communication network technology standard, for example, the wireless air interface is a new radio. Alternatively, the wireless air interface can also be a wireless air interface based on the technical standard of the next generation mobile communication network of 5G.

In some embodiments, end to end (E2E) connections can also be established between the UEs 110, for example, vehicle to vehicle (V2V) communication, vehicle to Infrastructure (V2I) communication and vehicle to pedestrian (V2P) communication in vehicle to everything (V2X) communication.

Herein, the UE can be considered as a terminal device of the following embodiments.

In some embodiments, the wireless communication system may further include a network management device 130.

A plurality of base stations 120 are respectively connected with a network management device 130. The network management device 130 may be a core network device in a wireless communication system. For example, the network management device 130 may be a mobility management entity (MME) in an evolved packet core (EPC). Alternatively, the network management device can also be other core network devices, such as serving gateway (SGW), public data network gateway (PGW), policy and charging rules function (PCRF) or home subscriber server (HSS). The embodiment of the present disclosure does not limit the implementation form of the network management device 130.

In order to facilitate the understanding of those skilled in the art, the embodiments of the present disclosure provide a plurality of embodiments to clearly explain the technical solution of the present disclosure. Of course, those skilled in the art can understand that the embodiments provided by the present disclosure can be performed alone, combined with the methods of other embodiments of the present disclosure, or together with some methods of other related arts. Embodiments of that present disclosure are not limited thereto.

It is to be noted that when a plurality of executing subjects are involved in the embodiments of the present disclosure, when an executing subject sends a certain transmission to another executing subject, it may mean that one executing subject sends the transmission directly to another executing subject, or it may mean that one executing subject sends the transmission to another executing subject through other arbitrary devices. This is not limited in the embodiments of the present disclosure.

In order to better understand the technical solutions in any an embodiment of the present disclosure, the related arts will be partially described below.

In an embodiment, as shown in FIG. 2, there is provided a 5GS LCS architecture model of non-roaming UE, and the architecture model includes a plurality of communication devices which include a core network device, an access network device, and external Location Service (LCS) client and Application Function (AF); for example, the communication devices include but not limited to at least one of: UE, device of RAN or AN((R)AN), Access and Mobility Management Function (AMF), Location Management Function (LMF), Unified Data Management (UDM), Network Exposure Function (NEF), Gateway Mobile Location Centre (GMLC), Location Retrieval Function (LRF), AF, and LCS client. Herein, interaction between the core network device and the UE or between the core network device and the access network device can be performed by a Non-Access Stratum (NAS); for example, the interaction between the UE and the AMF can be performed by N1 NAS message, and the interaction between the AMF and the access network device can be performed by N2NAS and the like.

In the above embodiment, a LCS client is an entity that interacts with the GMLC in order to obtain location information of one or more UEs. The LCS client can reside in the UE.

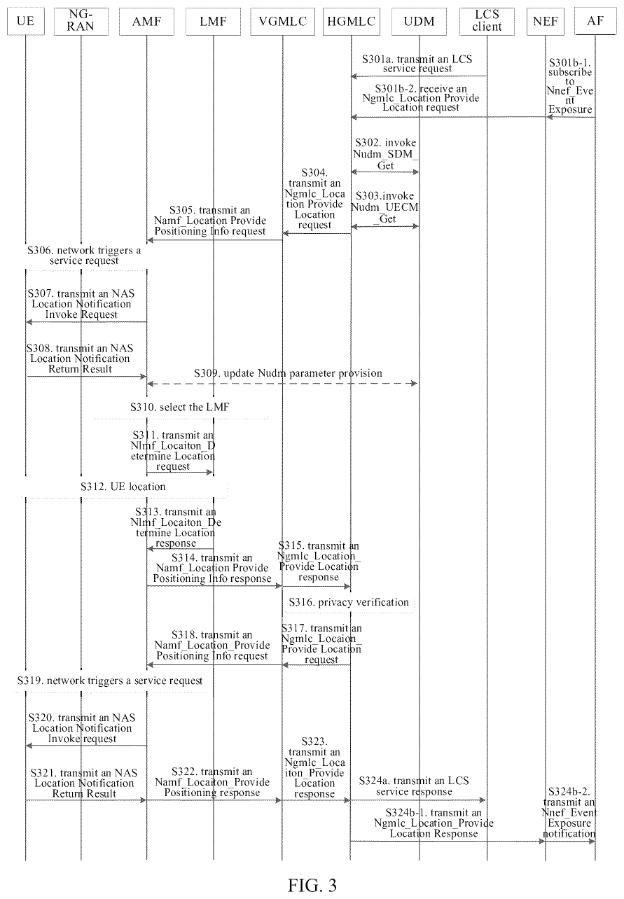

In an embodiment, as shown in FIG. 3, it is a schematic diagram illustrating a 5G-MT-LR process of a commercial location service. FIG. 3 shows a general network location required by the LCS client or AF. In this case, it is assumed that a target UE is identified by using Subscriber Permanent Identifier (SUPI) or Generic Public Subscription Identifier (GPSI). The 5G-MT-LR process of the commercial location service adapts to the request of the LCS client or AF for the current location of the target UE, with the assumption that:
privacy verification may be required for the location service request;
the LCS client or the AF needs to be authorised to use the location service.

With continuous reference to FIG. 3, the 5G-MT-LR process of the commercial location service includes the following steps.

At step S301a, the client transmits an LCS service request to HGMLC.

Herein, the HGMLC is a GMLC of a home network.

At step S301b-1, the AF subscribes to Nnef_Event Exposure from the NEF.

At step S301b-2, the HGMLC receives an Ngmlc_Location Provide Location request from the NEF.

At step S302, Nudm_SDM_Get is invoked.

At step S303, Nudm_UECM_Get is invoked.

At step S304, the HGMLC transmits an Ngmlc_Location Provide Location request to a VGMLC.

Herein, the VGMLC is a GMLC of a visited network.

At step S305, the VGMLC transmits an Namf_Location Provide Positioning Info request to the AMF.

At step S306, the network triggers a service request.

At step S307, the AMF transmits an NAS Location Notification Invoke Request to the UE.

At step S308, the UE transmits an NAS Location Notification Return Result to the AMF.

At step S309, Nudm parameter provision is updated.

At step S310, the LMF is selected.

At step S311, the AMF transmits an Nlmf_Locaiton_Determine Location request to the LMF.

At step S312, the UE performs location.

At step S313, the LFM transmits an Nlmf_Locaiton_Determine Location response to the AMF.

At step S314, the AMF transmits an Namf_Location Provide Positioning Info response to the VGMLC.

At step S315, the VGMLC transmits an Ngmlc_Location_Provide Location response to the HGMLC.

At step S316, the HGMLC performs privacy verification.

At step S317, the HGMLC transmits an Ngmlc_Locaion_Provide Location request to the VGMLC.

At step S318, the VGMLC transmits an Namf_Location_Provide Positioning Info request to the AMF.

At step S319, the network triggers a service request.

At step S320, the AMF transmits an NAS Location Notification Invoke request to the UE.

At step S321, the UE transmits an NAS Location Notification Return Result to the AMF.

At step S322, the AMF transmits an Namf_Locaiton_Provide Positioning response to the VGMLC.

At step S323, the VGMLC transmits an Ngmlc_Locaiton_Provide Location response to the HGMLC.

At step S324a, the HGMLC transmits an LCS service response to the LCS client.

At step S324b-1, the HGMLC transmits an Ngmlc_Location_Provide Location Response to the NEF.

At step S324b-2, the NEF transmits an Nnef_Event Exposure notification to the AF.

In the above embodiment, the HGMLC or GMLC invokes Nudm_SDM_Get to the UDM of the target UE to obtain the privacy setting of the GPSI or SUPI-identified UE. The UDM returns the privacy setting of the target UE to the UE. The HGMLC or GMLC detects UE LCS privacy profile. If it is not allowed to locate the target UE, the steps S303 to S323 are skipped.

In an embodiment, it is assumed that the owner and the operator have a protocol that the IoT device belongs to him or her and the UDM subscribes to the relationship of the UE and the IoT device, for example:
the UE subscription in the UDM: it (SUPI-1) owns the IoT device (SUPI-2);
the IoT device subscription in the UDM: it (SUPI-2) belongs to the UE (SUPI-1); in the TS 23.273 “LCS privacy profile data stored in the UDM for a UE Subscriber”; the LCS privacy profile is set as in Table 1 below.

TABLE 1

| Privacy | | |
|---|---|---|
| configuration | | |
| file data type | Presence | UDM data |
| Location | M | Indication of one of the following mutually exclusive global settings: |
| privacy | | Location is disallowed |
| indication | | Location is allowed (default) |
| | O | Time period when the Location Privacy Indication is valid |
| Call or | M | For any LCS client or AF not in the external LCS client list or otherwise |
| Session | | identified for the call/session unrelated class, the following data may be |
| unrelated | | present: |
| class | O | One of the following mutually exclusive options: |
| | | Location not allowed (default case) |
| | | Location allowed with notification |
| | | Location with notification and privacy verification; location allowed |
| | | if no response |
| | | Location with notification and privacy verification; location restricted |
| | | if no response |
| | O | Time period when positioning is allowed |
| | O | Geographical area where positioning is allowed |
| | O | Indication that codeword shall be checked in UE or one or more |
| | | codeword values to be checked in GMLC |
| | O | External LCS client list: a list of at least one LCS client, AFs and LCS Client |
| | | groups with the following data for each entry: |
| | O | One of the following mutually exclusive options: |
| | | Location allowed without notification (default case) |
| | | Location allowed with notification |
| | | Location with notification and privacy verification; location allowed |
| | | if no response |
| | | Location with notification and privacy verification; location |
| | | restricted if no response |
| | O | Time period when positioning is allowed |
| | O | Geographical area where positioning is allowed |

In an embodiment, only the LCS client in the external LCS client list (for example, a list of at least one LCS client, AFs and LCS Client groups) can locate the IoT device.

It can be understood that each element in the above Table 1 is independent and these elements are exemplified in a same table, which does not mean all elements in the Table must be present at the same time as shown in Table. The value of each element therein is not dependent on any other element value in the Table 1. Those skilled in the arts should understand that the value of each element in the Table 1 is one independent embodiment.

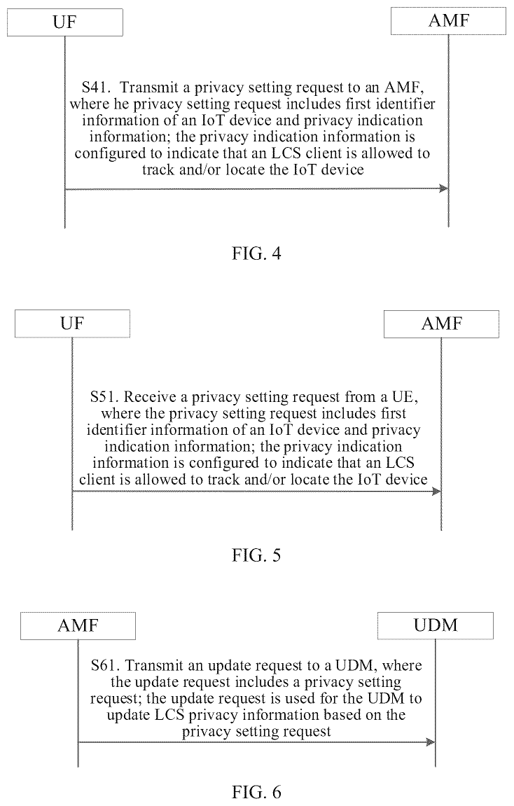

As shown in FIG. 4, an embodiment of the present disclosure provides an information processing method, which is performed by a User Equipment (UE) and includes the following step.

At step S41, a privacy setting request is transmitted to an AMF. The privacy setting request includes first identifier information of an IoT device and privacy indication information; the privacy indication information is configured to indicate that an LCS client is allowed to track and/or locate the IoT device.

Herein, the UE may be any mobile terminal or fixed terminal. For example, the UE may be but not limited to a smart phone, a computer, a server, a wearable device, a vehicle-mounted device, a road-side unit (RSU), a game control platform or a multimedia device or the like.

Herein, the AMF as well as UDM, network function (NF) and AF and the like involved in the following embodiments can be a logical node or function or the like flexibly deployed in a communication network. For example, the UDM may be a logical node or function at core network side, and the AF may be a node or function of core network side or third party.

Herein, in the step S41, the LCS client may be an external LCS client, namely, an LCS client outside the core network. In an embodiment, the LCS client may reside in the UE or not reside in the UE.

In an embodiment, the first identifier information of the IoT device is carried in the privacy setting request but not carried in the privacy indication information. Herein, the first identifier information of the IoT device and the privacy indication information are carried in different information domains of the privacy setting request.

In another embodiment, the first identifier information of the IoT device is carried in the privacy indication information.

In another embodiment, the privacy setting request includes but not limited to at least one of:
second identifier information of at least one LCS client;
second identifier information of at least one LCS client and/or at least one AF in at least one LCS client list.

Herein, one LCS client list may include at least one LCS client and/or at least one AF.

An embodiment of the present disclosure provides an information processing method, which is performed by a UE. The method includes: transmitting a privacy setting request to the AMF, where the privacy setting request includes first identifier information of an IoT device, second identifier information of at least one LCS client and/or at least one AF and privacy indication information; the privacy indication information is configured to indicate that at least one LCS client and/or at least one AF is allowed to track and/or locate the IoT device.

Herein, the second identifier information of the AF may be carried in the privacy setting request but not carried in the privacy indication information; or may be carried in the privacy indication information.

In an embodiment, the privacy indication information is configured to indicate that at least one LCS client and/or at least one AF is allowed to track and/or locate the IoT device.

Illustratively, the privacy indication information may be a first value, for example, “0” to indicate that a LCS client is allowed to track and/or locate the IoT device; or the privacy indication information may be a second value, for example, “1” to indicate that a LCS client is disallowed to track and/or locate the IoT device.

Illustratively, the privacy setting request includes the second identifier information of one LCS client, the second identifier information of one AF, and the first identifier information of one IoT device; the privacy indication information may be a first value, for example, “00” to indicate that the client is allowed to track and/or locate the IoT device and indicate that the AF is allowed to track and/or locate the IoT device; or the privacy indication information may be a second value, for example, “11” to indicate that the client is disallowed to track and/or locate the IoT device, and indicate that the AF is disallowed to track and/locate the IoT device; or, the privacy indication information may be a third value, for example, “01” to indicate that the client is allowed to track and/or locate the IoT device and indicate that the AF is disallowed to track and/or locate the IoT device. Herein, when the privacy indication information indicates that the LCS clients or AFs corresponding to a plurality of pieces of second identifier information are allowed to track and/or locate the IoT device or not, the indication can be performed sequentially based on an order of the second identifier information included in the privacy setting request or privacy setting indication.

Herein, the first identifier information may be configured to uniquely identify the IoT device; the second identifier information is configured to uniquely identify the LCS client and/or AF.

Herein, the first identifier information and the second identifier information each may be any identifier information. For example, the first identifier information and the second identifier information each may be but not limited to SUPI, SUCI, or GUPI or the like. For another example, the first identifier information and the second identifier information each may be a number or index agreed between a network device and the UE, or stated by communication protocol or the like.

In an embodiment of the present disclosure, the UE transmits a privacy setting request to the AMF, where the privacy setting request includes the first identifier information of the IoT device and the privacy indication information; the privacy indication information is configured to indicate that the LCS client is allowed to track and/or locate the IoT device. In this way, the AMF can be notified that the LCS client allows tracking and/or locating the IoT device; if the privacy setting request includes the second identifier information of the LCS client and/or the second identifier information of the AF, the AMF can be notified that which client or clients and/or which AF or AFs can be allowed to track and/or locate the IoT device.

Furthermore, since the privacy setting request is transmitted by the UE, the UE can also set LCS privacy information of the IoT device, that is, the UE can set which LCS client or clients to be allowed to track and/or locate the IoT device.

In some embodiments, the step S41 includes transmitting an NAS message to the AMF, where the NAS message includes the privacy setting request.

An embodiment of the present disclosure provides an information processing method, which is performed by a UE. The method includes transmitting an NAS message to the AMF, where the NAS message includes a privacy setting request.

In an embodiment, the NAS message may be an N1 NAS message.

In some other embodiments, the NAS message may also be another NAS message, and thus the type of the NAS message is not limited herein.

Of course, in other embodiments, the UE may transmit the privacy setting request to the AMF by another message and/or signaling, which is not limited herein.

It should be noted that those skilled in the arts should understand the method provided by the embodiments of the present disclosure can be separately performed or be performed together with some methods in the embodiments of the present disclosure or with some methods in the prior arts.

An embodiment of the present disclosure provides an information processing method, which is performed by a UE. The method includes: receiving a privacy setting response from the AMF, where the privacy setting response is configured to indicate that LCS privacy information is successfully set based on privacy indication information.

Herein, the privacy setting response is transmitted after the AMF determines based on subscription information that a UDM updates the LCS privacy information of an IoT device.

In an embodiment, the LCS privacy information is the LCS privacy profile in the above embodiments.

In another embodiment, the LCS privacy information is configured to indicate at least one LCS client and/or AF to perform at least one of:
allowing tracking and/or locating the IoT device;
in a case of notification, allowing tracking and/locating the IoT device;
in a case of no response to notification and/or privacy verification, allowing tracking and/locating the IoT device; or, in a case of no response to notification and/or privacy verification, disallowing tracking and/locating the IoT device;
a time period for allowing tracking and/or locating;
a geographical area for allowing tracking and/or locating.

In some embodiments, receiving the privacy setting response from the AMF includes:
receiving an NAS message from the AMF, where the NAS message includes the privacy setting response.

An embodiment of the present disclosure provides an information processing method, which is performed by a UE. The method includes: receiving an NAS message from an AMF, where the NAS message includes a privacy setting response.

In an embodiment of the present disclosure, the UE may, based on the privacy setting response from the AMF, determine the contents indicated by privacy indication information are successfully set.

It should be noted that those skilled in the arts should understand that the method provided by the embodiments of the present disclosure can be separately performed or be performed together with some methods in the embodiments of the present disclosure or with some methods in the prior arts.

The following information processing method performed by the AMF is described in a similar way to the information processing method performed by the UE; further, for the technical details not disclosed in the embodiments of the information processing method performed by the AMF, reference can be made to the descriptions of the examples of the information processing method performed by the UE and thus no redundant descriptions are made herein.

As shown in FIG. 5, an embodiment of the present disclosure provides an information processing method, which is performed by an AMF. The method includes the following step.

At step S51, a privacy setting request is received from a UE. The privacy setting request includes first identifier information of an IoT device and privacy indication information; the privacy indication information is configured to indicate that an LCS client is allowed to track and/or locate the IoT device.

In some embodiments of the present disclosure, the privacy setting request and the privacy indication information can be the privacy setting request and the privacy indication information in the step S41 respectively; the first identifier information of the IoT device may be the first identifier information of the IoT device in the step S41; the LCS client may be the LCS client in the step S41.

Illustratively, the privacy setting request may include but not limited to at least one of:
second identifier information of at least one LCS client;
second identifier information of at least one LCS client and/or at least one AF in at least one LCS client list.

Herein, one LCS client list may include at least one LCS client and/or at least one AF.

Illustratively, the AMF receives the privacy setting request from the UE, where the privacy setting request includes the first identifier information of the IoT device, the second identifier information of at least one LCS client and/or at least one AF, and the privacy indication information; the privacy indication information is configured to indicate that at least one LCS client and/or at least one AF is allowed to track and/or locate the IoT device.

Illustratively, the first identifier information of the IoT device may be carried in the privacy setting request but not carried in the privacy indication information, or the first identifier information of the IoT device may be carried in the privacy indication information.

Illustratively, the second identifier information may be carried in the privacy setting request but not carried in the privacy indication information or the second identifier information is carried in the privacy indication information.

Illustratively, the AMF receives an NAS message from the UE, where the NAS message carries the privacy setting request. The NAS message may be an N1 NAS message.

An embodiment of the present disclosure provides an information processing method, which is performed by an AMF. The method includes: transmitting a privacy setting response to a UE, where the privacy setting response is configured to indicate that LCS privacy information is successfully set based on privacy indication information.

In some embodiments of the present disclosure, the privacy setting response may be the privacy setting response in the above embodiments.

Herein, transmitting the privacy setting response to the UE may include: transmitting an NAS message to the UE, where the NAS message includes the privacy setting response.

For the specific descriptions of the above embodiment, reference can be made to the descriptions of the UE side and no redundant descriptions are made herein.

It should be noted that those skilled in the arts can understand that the method provided by the embodiments of the present disclosure can be separately performed or performed together with some methods in the embodiments of the present disclosure or with some methods in the prior arts.

As shown in FIG. 6, an embodiment of the present disclosure provides an information processing method, which is performed by an AMF. The method includes the following step.

At step S61, an update request is transmitted to a UDM, where the update request includes a privacy setting request; the update request is used for the UDM to update LCS privacy information based on the privacy setting request.

In some embodiments, the LCS privacy information is configured to indicate at least one of the followings of at least one LCS client and/or AF:
allowing tracking and/or locating an IoT device;
in a case of notification, allowing tracking and/locating the IoT device;
in a case of no response to notification and/or privacy verification, allowing tracking and/locating the IoT device; or, in a case of no response to notification and/or privacy verification, disallowing tracking and/locating the IoT device;
a time period for allowing tracking and/or locating;
a geographical area for allowing tracking and/or locating.

In some other embodiments, the LCS privacy information may be the LCS privacy profile in the above embodiments.

Herein, one IoT device may correspond to one piece of LCS privacy information or one LCS privacy profile. The LCS privacy information or LCS privacy profile stores the information that the IoT device can be tracked or located by which LCS client or LCS clients and/or which AF or AFs. Illustratively, if the LCS privacy information stores a cell phone number of a user A, a cell phone number of a user B and identifier information of an IoT device D, and at least one bit of the LCS privacy information is configured to indicate allowing tracking and/or locating the IoT device in a case of notification, the user A and the user B can be allowed to track and/or locate the IoT device in a case of notification.

Herein, if the privacy setting request includes a cell phone number of a user C and the privacy indication information in the privacy setting request indicates that the user C is allowed to track and/or locate the IoT device D, the cell phone number of the user C can be added to the LCS privacy information of the IoT device D to update the LCS privacy information of the IoT device D.

In an embodiment, the update request may be Nudm_parameter provision_Update.

Therefore, in the embodiments of the present disclosure, the AMF transmits the update request to the UDM; the update request includes the privacy setting request and the update request is used for the UDM to update the LCS privacy information based on the privacy setting request. In this way, it helps the UDM to, based on the update request, update the LCS privacy information of the IoT device stored by the UDM and helps the UDM to update in time the LCS privacy information of the IoT device.

In some embodiments, the method includes obtaining subscription information from the UDM.

Transmitting the update request to the UDM in the step S61 includes: based on the subscription information, determining the first identifier information belongs to third identifier information, and transmitting the update request to the UDM, where the third identifier information is the identifier information of the UE.

An embodiment of the present disclosure provides an information processing method, which is performed by an AMF. The method includes the followings:
obtaining subscription information from a UDM;
based on the subscription information, determining first identifier information belongs to third identifier information, and transmitting an update request to the UDM, where the third identifier information is identifier information of a UE.

In some embodiments, the subscription information includes but not limited to at least one of:
IoT subscription information for indicating that the first identifier information of at least one IoT device belongs to a subscription relationship of the third identifier information;
UE subscription information for indicating that the third identifier information of at last one UE possesses a subscription relationship of the first identifier information.

Herein, the subscription information may be IoT subscription information and/or UE subscription information; The IoT subscription information is configured to indicate the IoT device (first identifier information) belongs to the UE (third identifier information); and the UE subscription information is configured to indicate the UE (third identifier information) possesses the IoT device (first identifier information).

In some embodiments of the present disclosure, the first identifier information and the second identifier information are the first identifier information and the second identifier information in the above embodiments. Herein, the third identifier information may be configured to uniquely identify the UE. Illustratively, the first identifier information, the second identifier information and the third identifier information each may be but not limited to SUPI, SUCI, GUPI or number or index stated by communication protocol or agreed with the communication device or the like.

In an embodiment, the subscription information obtained by the AMF from the UDM includes: the UE subscription information. Therefore, based on the UE subscription information, whether the first identifier information belongs to the third identifier information can be determined, that is, it is determined whether the UE has permission to set who (e.g. LCS client and/or AF) can be allowed to track and/or locate the IoT device. In this way, the signaling interaction and the like can be reduced.

In another embodiment, the subscription information obtained by the AMF from the UDM includes: the UE subscription information and the IoT subscription information. Thus, whether the first identifier information belongs to the third identifier information can be accurately verified further so as to improve the reliability on whether the UE has permission for setting.

For the above embodiment, reference can be made to the descriptions of the UE side and no redundant descriptions are made herein.

It should be noted that those skilled in the arts can understand that the method provided by the embodiments of the present disclosure can be separately performed or performed together with some methods in the embodiments of the present disclosure or with some methods in the prior arts.

The following information processing method performed by the UDM is described in a similar way to the information processing method performed by the UE and/or AMF; further, for the technical details not disclosed in the embodiments of the information processing method performed by the AMF, reference can be made to the descriptions of examples of the information processing method performed by the UE and/or AMF and thus no redundant descriptions are made herein.

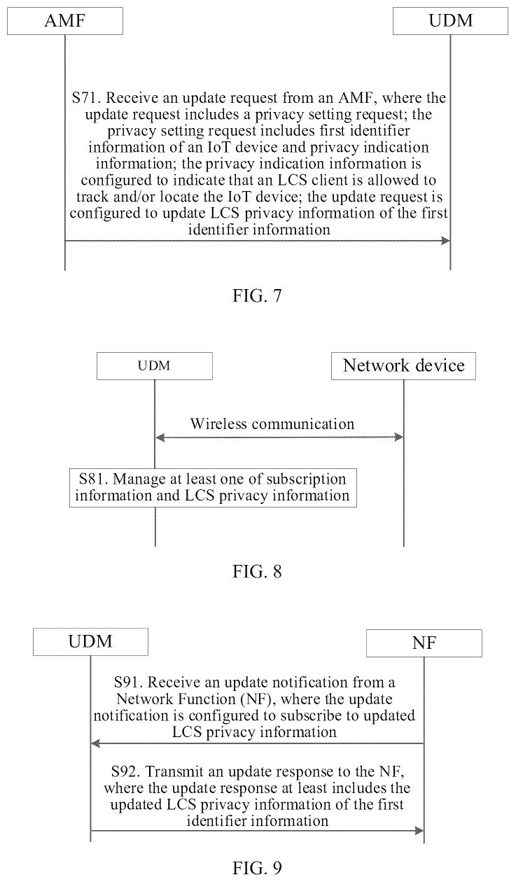

As shown in FIG. 7, an embodiment of the present disclosure provides an information processing method which is performed by a UDM. The method includes the following step.

At step S71, an update request is received from an AMF. The update request includes a privacy setting request; the privacy setting request includes first identifier information of an IoT device and privacy indication information; the privacy indication information is configured to indicate that an LCS client is allowed to track and/or locate the IoT device; the update request is configured to update LCS privacy information of the first identifier information.

In some embodiments of the present disclosure, the privacy setting request and the privacy indication information may be the privacy setting request and the privacy indication information in the step S41; the first identifier information of the IoT device may be the first identifier information of the IoT device in the step S41; the LCS client may be the LCS client in the step S41.

Illustratively, the privacy setting request includes but not limited to at least one of:
second identifier information of at least one LCS client;
second identifier information of at least one LCS client and/or at least one AF in at least one LCS client list.

Herein, one LCS client list may include at least one LCS client and/or at least one AF.

Illustratively, the privacy setting request includes the first identifier information of the IoT device, the second identifier information of at least one LCS client and/or at least one AF and the privacy indication information; the privacy indication information is configured to indicate that at least one LCS client and/or at least one AF is allowed to track and/or locate the IoT device.

In some embodiments of the present disclosure, the update request may be the update request in the step S61. Illustratively, the update request is transmitted after the AMF determines the first identifier information belongs to third identifier information.

For the above embodiment, reference can be made to the descriptions of the AMF side and no redundant descriptions are made herein.

It should be noted that those skilled in the arts can understand that the method provided by the embodiments of the present disclosure can be separately performed or performed together with some methods in the embodiments of the present disclosure or with some methods in the prior arts.

As shown in FIG. 8, an embodiment of the present disclosure provides an information processing method, which is performed by a UDM. The method includes the following step.

At step S81, at least one of subscription information and LCS privacy information is managed.

In some embodiments, the subscription information includes but not limited to at least one of:
IoT subscription information for indicating that first identifier information of at least one IoT device belongs to a subscription relationship of third identifier information;
UE subscription information for indicating that the third identifier information of at least one UE possesses a subscription relationship of the first identifier information;
In some embodiments, the LCS privacy information is configured to indicate at least one of the followings of at least one LCS client and/or AF:
allowing tracking and/or locating the IoT device;
in a case of notification, allowing tracking and/locating the IoT device;
in a case of no response to notification and/or privacy verification, allowing tracking and/locating the IoT device; or, in a case of no response to notification and/or privacy verification, disallowing tracking and/locating the IoT device;
a time period for allowing tracking and/or locating;
a geographical area for allowing tracking and/or locating.

In some other embodiments, the LCS privacy information is the LCS privacy profile in the above embodiments.

In some embodiments, the step S81 at least includes: storing and/or updating at least one of the subscription information and the LCS privacy information.

An embodiment of the present disclosure provides an information processing method, which is performed by a UDM. The method includes at least one of the followings:
storing the subscription information and/or LCS privacy information;
updating the subscription information and/or LCS privacy information.

In an embodiment of the present disclosure, the UDM may be configured to manage the UE subscription information of at least one UE and/or the IoT subscription information of at least one IoT device; and/or, the UDM is further configured to manage the LCS privacy information of at least one IoT device. Therefore, it helps the core network device or another device or the like to query for these subscription information and/or these LCS privacy information and the like.

An embodiment of the present disclosure provides an information processing method, which is performed by a UDM. The method includes: based on subscription information, determining first identifier information belongs to third identifier information and adding second identifier information to LCS privacy information of the first identifier information.

In some embodiments of the present disclosure, the first identifier information, the second identifier information and the third identifier information may be the first identifier information, the second identifier information and the third identifier information in the above embodiments.

Herein, if the first identifier information carried in the update request belongs to the third identifier information, it is determined that the IoT device corresponding to the first identifier information belongs to the UE corresponding to the third identifier information; at this time, the UE corresponding to the third identifier information has permission to set the LCS privacy information for the IoT device corresponding to the first identifier information.

Illustratively, the UDM stores the LCS privacy information of at least one IoT device; the UDM, based on the first identifier information carried in the update request, obtains the LCS privacy information of the IoT device corresponding to the first identifier information from a UDM database and stores the second identifier information correspondingly in the LCS privacy information of the first identifier information. The second identifier information may be the second identifier information of one or more LCS clients and/or may be the second identifier information of one or more AFs, and/or may be the second identifier information of the LCS clients and/or AFs in one or more LCS client lists.

In an embodiment of the present disclosure, the UDM may add the second identifier information into the LCS privacy information of the first identifier information. Thus, the LCS privacy information in the UDM can be updated in time and the setting of the UE for the LCS privacy information of the IoT device can be completed.

For the above embodiment, reference can be made to the descriptions of the AMF side and no redundant descriptions are made herein.

It should be noted that those skilled in the arts can understand that the method provided by the embodiments of the present disclosure can be separately performed or performed together with some methods in the embodiments of the present disclosure or with some methods in the prior arts.

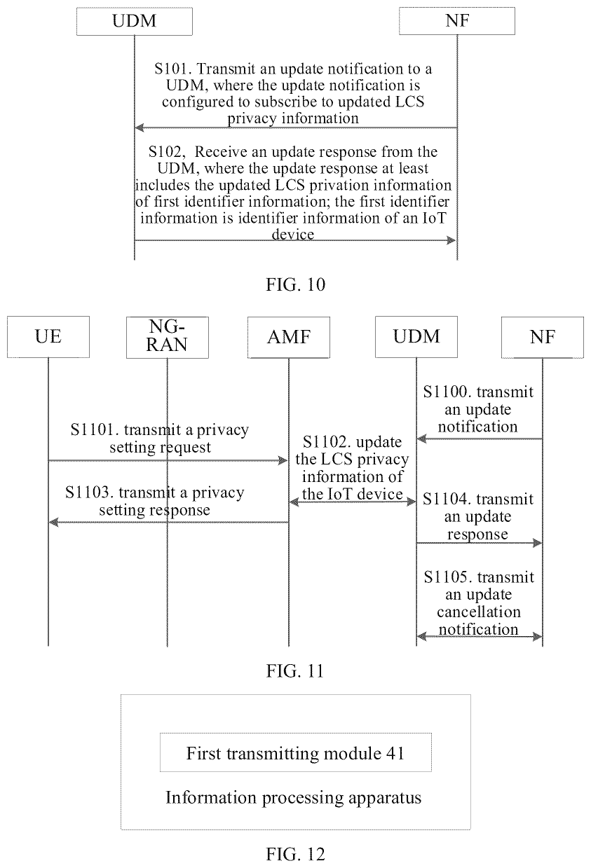

As shown in FIG. 9, an embodiment of the present disclosure provides an information processing method, which is performed by a UDM. The method includes the following steps.

At step S91, an update notification is received from a Network Function (NF), where the update notification is configured to subscribe to updated LCS privacy information.

At step S92, an update response is transmitted to the NF, where the update response at least includes the updated LCS privacy information of the first identifier information.

In an embodiment, the update response may also include: updated LCS privacy information of at least one IoT device.

In an embodiment of the present disclosure, after receiving the update notification from the NF, the UDM transmits the updated LCS privacy information corresponding to the first identifier information to the NF such that the NF can obtain the updated LCS privacy information of the first identifier information. Thus, it helps the NF to perform subsequent location operations and the like based on the updated LCS privacy information of the first identifier information.

An embodiment of the present disclosure provides an information processing method, which is performed by a UDM. The method includes: based on receiving an update cancellation notification from the NF, stopping transmitting the updated LCS privacy information to the NF.

An embodiment of the present disclosure provides an information processing method, which is performed by a UDM. The method includes: based on receiving an update cancellation notification from the NF, stopping transmitting the updated LCS privacy information of the first identifier information to the NF.

Herein, the update cancellation notification is configured to unsubscribe to the updated LCS privacy information.

Thus, in the embodiments of the present disclosure, when the UDM receives the update cancellation notification from the NF, the UDM can, in time, stop transmitting the updated LCS privacy information to the NF. In this way, the signaling overhead can be reduced and the power consumption of the UDM and NF can be saved.

For the above embodiment, reference can be made to the descriptions of the AMF side and no redundant descriptions are made herein.

It should be noted that those skilled in the arts can understand that the method provided by the embodiments of the present disclosure can be separately performed or performed together with some methods in the embodiments of the present disclosure or with some methods in the prior arts.

The following information processing method performed by the NF is described in a similar way to the information processing method performed by the UE and/or AMF and/or UDM; further, for the technical details not disclosed in the embodiments of the information processing method performed by the NF, reference can be made to the descriptions of examples of the information processing method performed by the UE and/or AMF and/or UDM and thus no redundant descriptions are made herein.

As shown in FIG. 10, an embodiment of the present disclosure provides an information processing method, which is performed by an NF. The method includes the following steps.

At step S101, an update notification is transmitted to a UDM, where the update notification is configured to subscribe to updated LCS privacy information.

At step S102, an update response is received from the UDM, where the update response at least includes the updated LCS privation information of first identifier information; the first identifier information is identifier information of an IoT device.

In some embodiments of the present disclosure, the update notification may be the update notification in the step S91; the update response may be the update response in the step S92; the first identifier information may be the first identifier information in the above embodiment; the LCS privacy information may be the LCS privacy information in the above embodiment. Illustratively, the update response includes the updated LCS privacy information.

An embodiment of the present disclosure provides an information processing method, which is performed by an NF. The method includes: transmitting an update cancellation notification to a UDM, where the update cancellation notification is configured to notify stopping transmitting updated LCS privacy information.

In some embodiments of the present disclosure, the update cancellation notification is the update cancellation notification in the above embodiment.

For the above embodiment, reference can be made to the descriptions of the UDM side and no redundant descriptions are made herein.

It should be noted that those skilled in the arts can understand that the method provided by the embodiments of the present disclosure can be separately performed or performed together with some methods in the embodiments of the present disclosure or with some methods in the prior arts.

The following information processing method performed by a communication device is described in a similar way to the information processing method performed by the UE and/or AMF and/or UDM and/or NF; further, for the technical details not disclosed in the embodiments of the information processing method performed by the communication device, reference can be made to the descriptions of examples of the information processing method performed by the UE and/or AMF and/or UDM and/or NF and thus no redundant descriptions are made herein.

An embodiment of the present disclosure provides an information processing method, which includes the following steps.

An NF transmits an update notification to a UDM, where the update notification is configured to subscribe to updated LCS privacy information.

A UE transmits a privacy setting request to an AMF. The privacy setting request includes: first identifier information of an IoT device, second identifier information of at least one LCS client, and privacy indication information; the privacy indication information is configured to indicate that the LCS client is allowed to track and/or locate the IoT device.

After receiving the privacy setting request, the AMF transmits an update request carrying the privacy setting request to the UDM.

The UDM, based on the update request and subscription information, determines the first identifier information belongs to third identifier information and adds the second identifier information into the LCS privacy information of the first identifier information; the third identifier information is identifier information of the UE.

The UDM transmits an update response to the NF; the update response at least includes update LCS privacy information of the first identifier information.

In some embodiments of the present disclosure, the update notification and the update response may be the update notification and the update response in the above embodiments respectively; the privacy setting request and the privacy indication information may be the privacy setting request and the privacy indication information in the above embodiments respectively; the first identifier information, the second identifier information and the third identifier information may be the first identifier information, the second identifier information and the third identifier information in the above embodiments respectively; the update request may be the update request in the above embodiments.

For the above embodiment, reference can be made to the descriptions of the UE and/or AMF and/or NF side and no redundant descriptions are made herein.

It should be noted that those skilled in the arts can understand that the method provided by the embodiments of the present disclosure can be separately performed or performed together with some methods in the embodiments of the present disclosure or with some methods in the prior arts.

In order to further interpret any embodiment of the present disclosure, a specific embodiment is provided below.

As shown in FIG. 11, an embodiment of the present disclosure provides an information processing method, which is performed by a communication device which includes UE, AMF, UDM and NF. The information processing method includes the following steps.

At step S1100, the NF transmits an update notification to the UDM.

In an embodiment, the update notification is configured to initiate LCS privacy setting process of an IoT device and subscribes to updated LCS privacy information from the UDM.

Herein, the NF may be GMLC.

In an embodiment, the NF transmits the update notification to the UDM.

At step S1101, the UE transmits a privacy setting request to the AMF.

In an embodiment, the UE transmits an N1 NAS message to the AMF. The N1 NAS message includes the privacy setting request; the privacy setting request includes first identifier information of the IoT device, second identifier information of at least one LCS client, and privacy indication information; the privacy indication information is configured to indicate that an LCS client is allowed to track and/or locate the IoT device. Herein, the second identifier information may be identifier information of the AF.

At step S1102, the LCS privacy information of the IoT device is updated.

In an embodiment, after the AMF receives the privacy setting request, the AMF determines based on subscription information that the first identifier information belongs to third identifier information, and invokes Nudm_parameter provision_Update to the UDM; the Nudm_parameter provision_Update includes: the privacy setting request; the privacy setting request includes the first identifier information of the IoT device, the second identifier information of at least one LCS client, and the privacy indication information; the privacy indication information is configured to indicate that an LCS client is allowed to track and/or locate the IoT device; the Nudm_parameter provision_Update is configured to update the LCS privacy information of the IoT device corresponding to the first identifier information. When the UDM receives the Nudm_parameter provision_Update, if the UDM determines based on the subscription information that the first identifier information belongs to the third identifier information, the UDM adds the second identifier information to the LCS privacy information of the first identifier information to update the LCS privacy information of the IoT device corresponding to the first identifier information.

At step S1103, the AMF transmits a privacy setting response to the UE.

In an embodiment, the AMF transmits an N1 NAS message to the UE. The N1 NAS message includes the privacy setting response; the privacy setting response is configured to indicate that the LCS privacy information of the IoT device corresponding to the first identifier information is successfully set based on the privacy indication information.

At step S1104, the UDM transmits an update response to the NF.

In an embodiment, the UDM transmits an Nudm_SDM_Notification Notify message to the NF. The Nudm_SDM_Notification Notify includes the update response; the update response at least includes updated LCS privacy information of the first identifier information.

At step S1105, the NF transmits an update cancellation notification to the UDM.

In an embodiment, the NF transmits the update cancellation notification to the UDM. The update cancellation notification is configured to notify stopping transmitting the updated LCS privacy information. Herein, it is possible that the network device cancels a delayed location process.

Herein, the NF may be GMLC or NEF.

In some application scenarios, after the above step S1105, in the 5GC-MT-LR process of commercial location service shown in FIG. 3, when the NF (e.g. GMLC) obtains the LCS privacy information (e.g. LCS privacy profile) of the IoT device from the UDM in the step S302, the NF (e.g. GMLC) may check the external LCS client list in the LCS privacy information to determine whether to allow the LCS client and/or AF in the LCS client list to track and/or locate the IoT device. In this way, it can be further detected whether the UE has permission to set who can track and/or locate the IoT device.

It is to be noted that those skilled in the art may understand that the methods provided by the embodiments of the present disclosure, may be performed alone or in conjunction with some of the methods in the embodiments of the present disclosure or some of the methods in related art.

As shown FIG. 12, the embodiments of the present disclosure provide an information processing apparatus. The information processing apparatus includes a first transmitting module 41.

The first transmitting module 41 is configured to transmit a privacy setting request to an access and mobility management function (AMF), where the privacy setting request includes first identifier information of an internet-of-things (IoT) device and privacy indication information, and the privacy indication information is configured to indicate that a location service (LCS) client is allowed to track and/or locate the IoT device.

The information processing apparatus provided by the embodiments of the present disclosure is applied to a UE.

In some embodiments, the privacy setting request further includes at least one of:
second identifier information of at least one LCS client; or
second identifier information of at least one LCS client and/or at least one application function (AF) in at least one LCS client list.

The embodiments of the present disclosure provide an information processing apparatus. The information processing apparatus includes a first transmitting module 41, configured to transmit a privacy setting request to an AMF, where the privacy setting request includes first identifier information of an IoT device, a second identifier information of at least one LCS client and/or AF and privacy indication information, and the privacy indication information is configured to indicate that at least one LCS client and/or AF is allowed to track and/or locate the IoT device.

The embodiments of the present disclosure provide an information processing apparatus. The information processing apparatus includes a first transmitting module 41, configured to transmit a non-access stratum (NAS) message to the AMF, where the NAS message includes the privacy setting request.

The embodiments of the present disclosure provide an information processing apparatus. The information processing apparatus includes a first receiving module, configured to receive a privacy setting response from the AMF, where the privacy setting response is configured to indicate that LCS privacy information is successfully set based on the privacy indication information.

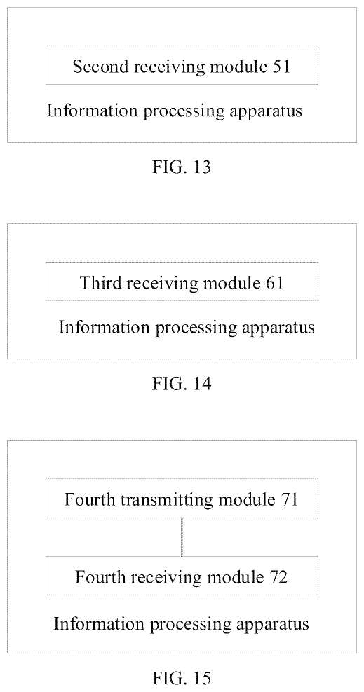

As shown FIG. 13, the embodiments of the present disclosure provide an information processing apparatus. The information processing apparatus includes a second receiving module 51.

The second receiving module 51 is configured to receive a privacy setting request from a user equipment (UE), where the privacy setting request includes first identifier information of an internet-of-things (IoT) device and privacy indication information, and the privacy indication information is configured to indicate that a location service (LCS) client is allowed to track and/or locate the IoT device.

The information processing apparatus provided by the embodiments of the present disclosure is applied to the AMF.

In some embodiments, the privacy setting request further includes at least one of:
second identifier information of at least one LCS client; or
second identifier information of at least one LCS client and/or at least one application function (AF) in at least one LCS client list.

The embodiments of the present disclosure provide an information processing apparatus. The information processing apparatus includes a second transmitting module, configured to transmit an update request to a unified data management (UDM), where the update request includes the privacy setting request, and the update request is used for the UDM to update LCS privacy information based on the privacy setting request.

The embodiments of the present disclosure provide an information processing apparatus. The information processing apparatus includes a second receiving module 51 and a second transmitting module.

The second receiving module 51 is configured to obtain subscription information from a UDM.

The second transmitting module is configured to determine, based on the subscription information, that the first identifier information belongs to the third identifier information, and transmit an update request to the UDM, where the third identifier information is identifier information of the UE.

In some embodiments, the subscription information includes UE subscription information for indicating that the third identifier information of one UE is used for a subscription relationship of the first identifier information.

In some embodiments, the subscription information includes: IoT subscription information and UE subscription information.

The IoT subscription information is configured to indicate that the first identifier information of at least one IoT device belongs to a subscription relationship of the third identifier information; and

The UE subscription information is configured to indicate that the third identifier information of at least one UE possesses a subscription relationship of the first identifier information.

In some embodiments, the LCS privacy information is configured to indicate that, for at least one LCS client, at least one of:
tracking and/or locating the IoT device is allowed;
in response to there being notification, tracking and/or locating the IoT device is allowed;
in response to there being no response to the notification and/or privacy verification, tracking and/or locating the IoT device is allowed; or in response to there being no response to the notification and/or the privacy verification, tracking and/or locating the IoT device is disallowed;
a time period for allowing tracking and/or locating; or
a geographical area for allowing tracking and/or locating.

The embodiments of the present disclosure provide an information processing apparatus. The information processing apparatus includes a second transmitting module, configured to transmit a privacy setting response to the UE, where the privacy setting response is configured to indicate that the LCS privacy information is successfully set based on the privacy indication information.

The embodiments of the present disclosure provide an information processing apparatus. The information processing apparatus includes a second receiving module 51, configured to receive a non-access stratum (NAS) message from the UE, where the NAS message includes the privacy setting request.

As shown FIG. 14, the embodiments of the present disclosure provide an information processing apparatus. The information processing apparatus includes a third receiving module 61.

The third receiving module 61 is configured to receive an update request from an access and mobility management function (AMF), where the update request includes a privacy setting request, the privacy setting request includes first identifier information of an internet-of-things (IoT) device and privacy indication information, the privacy indication information is configured to indicate that a location service (LCS) client is allowed to track and/or locate the IoT device, and the update request is configured to update LCS privacy information of the first identifier information.

The information processing apparatus provided by the embodiments of the present disclosure is applied to the UDM.

In some embodiments, the privacy setting request further includes at least one of:
second identifier information of at least one LCS client; or
second identifier information of at least one LCS client and/or at least one application function (AF) in at least one LCS client list.

The embodiments of the present disclosure provide an information processing apparatus. The information processing apparatus includes a processing module, configured to manage at least one of subscription information and the LCS privacy information.

In some embodiments, the subscription information includes at least one of:
IoT subscription information for indicating that the first identifier information of at least one IoT device belongs to a subscription relationship of third identifier information; or
UE subscription information for indicating that the third identifier information of at least one UE possesses a subscription relationship of the first identifier information.

In some embodiments, the LCS privacy information is configured to indicate that, for at least one LCS client, at least one of:
tracking and/or locating the IoT device is allowed;
in response to there being notification, tracking and/or locating the IoT device is allowed;
in response to there being no response to the notification and/or privacy verification, tracking and/or locating the IoT device is allowed; or in response to there being no response to the notification and/or the privacy verification, tracking and/or locating the IoT device is disallowed;
a time period for allowing tracking and/or locating; or
a geographical area for allowing tracking and/or locating.

The embodiments of the present disclosure provide an information processing apparatus. The information processing apparatus includes a processing module, configured to determine, based on the subscription information, that the first identifier information belongs to the third identifier information, and add the second identifier information to the LCS privacy information of the first identifier information.

The embodiments of the present disclosure provide an information processing apparatus. The information processing apparatus includes a third receiving module 61 and a transmitting module.

The third receiving module 61 is configured to receive an update notification from a network function (NF), where the update notification is configured to subscribe to the updated LCS privacy information; and

The transmitting module is configured to transmit an update response to the NF, where the update response includes at least the updated LCS privacy information of the first identifier information.

The embodiments of the present disclosure provide an information processing apparatus. The information processing apparatus includes a processing module, configured to stop, based on receiving an update cancellation notification from the NF, transmitting the updated LCS privacy information to the NF.

As shown FIG. 15, the embodiments of the present disclosure provide an information processing apparatus. The information processing apparatus includes a fourth transmitting module 71 and a fourth receiving module 72.

The fourth transmitting module 71 is configured to transmit an update notification to a unified data management (UDM), where the update notification is configured to subscribe to updated location service (LCS) privacy information; and

The fourth receiving module 72 is configured to receive an update response from the UDM, where the update response includes at least the updated LCS privacy information of first identifier information, and the first identifier information is identifier information of an internet-of-things (IoT) device.

The information processing apparatus provided by the embodiments of the present disclosure is applied to the NF.

The embodiments of the present disclosure provide an information processing apparatus. The information processing apparatus includes a fourth transmitting module, configured to transmit an update cancellation notification to the UDM, where the update cancellation notification is configured to notify stopping transmitting the updated LCS privacy information.

It is to be noted that those skilled in the art may understand that the apparatuses provided by the embodiments of the present disclosure, may be performed alone, or in conjunction with some of the apparatuses in the embodiments of the present disclosure or some of the apparatuses in the related art.

With respect to the apparatus in the embodiments, the specific manner in which each module performs an operation has been described in detail in the embodiments relating to the method, and will not be described in detail herein.

The embodiments of the present disclosure provide a communication device, including:
a processor; and
a memory storing instructions executable by the processor;
where the instructions, when executed by the processor, cause the processor to perform the information processing method of any one of the embodiments of the present disclosure.

In an embodiment, the communication device may include, but is not limited to, at least one of: an AF, a UE, an AMF, a UDM, and a NF.

The processor may include various types of storage medium that are non-transitory computer storage medium capable of continuing to memorize information stored thereon after the user device is powered down.

The processor may be coupled to the memory via a bus, etc., for reading executable programs stored on the memory, e.g., at least one of the methods as illustrated in FIGS. 4 to 11.

The embodiments of the present disclosure provide a computer storage medium, storing computer-executable programs thereon, where the computer-executable programs, when executed by a processor, cause the processor to perform the information processing method of any one of the embodiments of the present disclosure, e.g., at least one of the methods as illustrated in FIGS. 4 to 11.

Regarding the apparatuses or storage medium in the above examples, the specific manner in which each module performs operations has been described in detail in the examples of the methods, and will not be described in detail here.

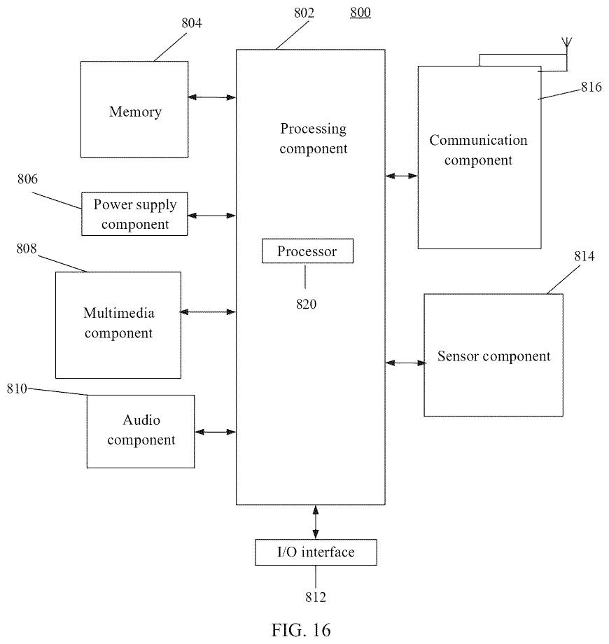

FIG. 16 is a block diagram illustrating a UE 800 according to an embodiment of the present disclosure. For example, the UE 800 may be a mobile phone, a computer, a digital broadcast UE, a message transceiving device, a game console, a tablet device, a medical device, a fitness device and a personal digital assistant and so on.

As shown in FIG. 16, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls overall operations of the UE 800, such as operations associated with display, phone calls, data communications, camera operations, and recording operations. The processing component 802 may include one or more processors 820 to execute instructions to complete all or a part of the steps of the above methods. In addition, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store different types of data to support operations at the UE 800. Examples of such data include instructions of any application program or method operable on the UE 800, contact data, telephone directory data, messages, pictures, videos, and the like. The memory 804 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power supply component 806 provides power to different assemblies of the UE 800. The power supply component 806 may include a power supply management system, one or more power supplies, and other components associated with generating, managing and distributing power for the UE 800.

The multimedia component 808 may include a screen for providing an output interface between the UE 800 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 808 may include a front camera and/or a rear camera. When the UE 800 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 810 is configured to output and/or input an audio signal. For example, the audio component 810 may include a microphone (MIC). When the UE 800 is in an operating mode, such as a call mode, a recording mode and a speech recognition mode, the microphone is configured to receive an external audio signal. The received audio signal may be further stored in the memory 804 or sent via the communication component 816. In some examples, the audio component 810 also includes a speaker for outputting an audio signal.

The I/O interface 812 may provide an interface between the processing component 802 and peripheral interface modules. The above peripheral interface modules may include a keyboard, a click wheel, buttons and so on. Such buttons may include but not limited to: a home button, a volume button, a start button and a lock button.

The sensor component 814 may include one or more sensors for providing state assessments in different aspects for the UE 800. For example, the sensor component 814 may detect the on/off state of the UE 800, and relative locations of components, such as a display and a small keyboard of the UE 800. The sensor component 814 may also detect a position change of the UE 800 or a component of the UE 800, the presence or absence of contact of a user with the UE 800, an orientation or acceleration/deceleration of the UE 800 and a temperature change of the UE 800. The sensor component 814 may include a proximity sensor for detecting the existence of a nearby object without any physical touch. The sensor component 814 may also include a Complementary Metal-Oxide-Semiconductor (CMOS) or Charged Coupled Device (CCD) image sensor applied in an imaging application. In some examples, the sensor component 814 may also include an acceleration sensor, a gyro sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 4G or 5G, or a combination thereof. In examples, the communication component 816 receives a broadcast signal or broadcast related information from an external broadcast management system via a broadcast channel. In examples, the communication component 816 may also include a Near Field Communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology and other technologies.

In some illustrative embodiments, the UE 800 may be implemented by one or more of an application-specific integrated circuit (ASIC), a digital signal processor (DSP), a digital signal processing device (DSPD), programmable logical device (PLD), field programmable gate array (FPGA), a controller, microcontroller, a microprocessor or other electronic components to execute the above methods.

In an example, a non-transitory machine readable storage medium storing machine executable instructions is provided, such as the memory 804 storing instructions. The instructions may cause the processor 820 in the UE 800 to perform the above method. For example, the non-transitory computer readable storage medium may be a read-only memory (ROM), a random access memory (RAM), a CD-ROM, a magnetic tape, a floppy disk and an optical data storage device, etc.

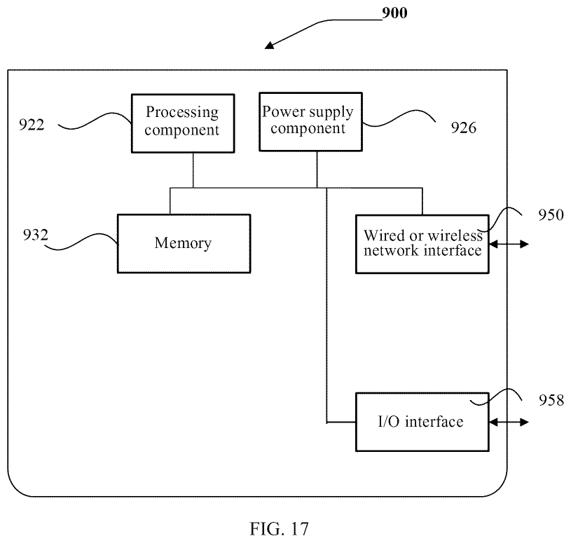

FIG. 17 is a block diagram illustrating a base station according to an embodiment of the present disclosure. For example, the base station 900 may be provided as a network device. Referring to FIG. 17, the base station 900 includes a processing component 922, which further includes one or more processors, and memory resources represented by a memory 932 for storing instructions, such as an application program, that may be executed by the processing component 922. The application program stored in the memory 932 may include one or more modules each corresponding to a set of instructions. In addition, the processing component 922 is configured to execute the instructions to perform the method of any one of the embodiments of the present disclosure.

The base station 900 may also include a power supply component 926 configured to perform power management of the base station 900, a wired or wireless network interface 950 configured to connect the base station 900 to a network, and an input/output (I/O) interface 958. The base station 900 may operate an operating system based on an operating system stored in the memory 932, such as Windows Server™, Mac OS X™, Unix™, Linux™, FreeBSD™ or the like.

The technical solutions provided by the embodiments of the present disclosure have the following beneficial effects.

In the embodiments of the present disclosure, the UE transmits a privacy setting request to the AMF; the privacy setting request includes the first identifier information of the IoT device and the privacy indication information; and the privacy indication information is configured to indicate that the LCS client is allowed to track and/or locate the IoT device. In this way, the AMF can be notified that the LCS client allows tracking and/or locating the IoT device. Further, since the privacy setting request is transmitted by the UE, the UE can also set LCS privacy information of the IoT device, that is, the UE can set which LCS client or clients to be allowed to track and/or locate the IoT device.

Other embodiments of the present disclosure will be readily apparent to those skilled in the art after considering the specification and practicing the contents disclosed herein. The present disclosure is intended to cover any variations, uses, modification or adaptations of the present disclosure that follow the general principles thereof and include common knowledge or conventional technical means in the art that are not disclosed in the present disclosure. The specification and examples are to be regarded as illustrative only. The true scope and spirit of the present disclosure are pointed out by the following claims.

It is to be understood that the present disclosure is not limited to the precise construction described herein and shown in the drawings, and that various modifications and changes may be made without departing from the scope thereof. The scope of the present disclosure is to be limited only by the appended claims.

1. An information processing method, performed by a user equipment (UE) and comprising:
transmitting a privacy setting request to an access and mobility management function (AMF), wherein the privacy setting request comprises first identifier information of an internet-of-things (IoT) device and privacy indication information, and the privacy indication information is configured to indicate that a location service (LCS) client is allowed to perform at least one of tracking or locating on the IoT device.

2. The method of claim 1, wherein the privacy setting request further comprises at least one of:
second identifier information of at least one LCS client; or
at least one of second identifier information of at least one LCS client, or at least one application function (AF) in at least one LCS client list.

3. The method of claim 1, wherein transmitting the privacy setting request to the AMF comprises:
transmitting a non-access stratum (NAS) message to the AMF, wherein the NAS message comprises the privacy setting request.

4. The method of claim 1, further comprising:
receiving a privacy setting response from the AMF, wherein the privacy setting response is configured to indicate that LCS privacy information is successfully set based on the privacy indication information.

5. An information processing method, performed by an access and mobility management function (AMF) and comprising:
receiving a privacy setting request from a user equipment (UE), wherein the privacy setting request comprises first identifier information of an internet-of-things (IoT) device and privacy indication information, and the privacy indication information is configured to indicate that a location service (LCS) client is allowed to perform at least one of tracking or locating on the IoT device.

6. The method of claim 5, wherein the privacy setting request further comprises at least one of:
second identifier information of at least one LCS client; or
at least one of second identifier information of at least one LCS client, or at least one application function (AF) in at least one LCS client list.

7. The method of claim 6, further comprising:
transmitting an update request to a unified data management (UDM), wherein the update request comprises the privacy setting request, and the update request is [used] configured for the UDM to update LCS privacy information based on the privacy setting request.

8. The method of claim 7, further comprising: obtaining subscription information from the UDM;
wherein transmitting the update request to the UDM comprises:
determining, based on the subscription information, that the first identifier information belongs to third identifier information, and transmitting the update request to the UDM, wherein the third identifier information is identifier information of the UE.

9. The method of claim 8, wherein
the subscription information comprises:
UE subscription information for indicating that the third identifier information of one UE possesses a subscription relationship of the first identifier information;
or
the subscription information comprises:
IoT subscription information for indicating that the first identifier information of at least one IoT device belongs to a subscription relationship of the third identifier information; and
UE subscription information for indicating that the third identifier information of at least one UE possesses a subscription relationship of the first identifier information.

10. The method of claim 7, wherein the LCS privacy information is configured to indicate that, for at least one LCS client, at least one of:
at least one of tracking and/or or locating the IoT device is allowed;
in response to there being notification, at least one of tracking or locating the IoT device is allowed;
in response to there being no response to at least one of the notification or privacy verification, at least one of tracking or locating the IoT device is allowed or disallowed;
a time period for allowing at least one of tracking or locating; or
a geographical area for allowing at least one of tracking or locating.

11. The method of claim 8, further comprising:
transmitting a privacy setting response to the UE, wherein the privacy setting response is configured to indicate that the LCS privacy information is successfully set based on the privacy indication information.

12. The method of claim 4, wherein receiving the privacy setting request from the UE comprises:
receiving a non-access stratum (NAS) message from the UE, wherein the NAS message comprises the privacy setting request.

13. An information processing method, performed by a unified data management (UDM) and comprising:
receiving an update request from an access and mobility management function (AMF), wherein the update request comprises a privacy setting request, the privacy setting request comprises first identifier information of an internet-of-things (IoT) device and privacy indication information, the privacy indication information is configured to indicate that a location service (LCS) client is allowed to perform at least one of tracking or locating on the IoT device, and the update request is configured to update LCS privacy information of the first identifier information.

14. The method of claim 13, wherein the privacy setting request further comprises at least one of:
second identifier information of at least one LCS client; or
at least one of second identifier information of at least one LCS client or at least one application function (AF) in at least one LCS client list.

15. The method of claim 13, further comprising:
managing at least one of subscription information or the LCS privacy information.

16. The method of claim 15, wherein the subscription information comprises at least one of:
IoT subscription information for indicating that the first identifier information of at least one IoT device belongs to a subscription relationship of third identifier information; or
UE subscription information for indicating that the third identifier information of at least one UE possesses a subscription relationship of the first identifier information.

17. (canceled)

18. The method of claim 15, further comprising:
determining, based on the subscription information, that the first identifier information belongs to the third identifier information, and adding the second identifier information to the LCS privacy information of the first identifier information.

19. The method of claim 13, further comprising:
receiving an update notification from a network function (NF), wherein the update notification is configured to subscribe to the updated LCS privacy information; and
transmitting an update response to the NF, wherein the update response comprises at least the updated LCS privacy information of the first identifier information.

20. The method of claim 13, further comprising:
stopping, based on receiving an update cancellation notification from the NF, transmitting the updated LCS privacy information to the NF.

21.-27. (canceled)

28. A communication device, comprising:
a processor; and
a memory storing instructions executable by the processor;
wherein the processor is configured to perform the method of claim 1.

29. (canceled)
